(19) United States
(12) Patent Application Publication
(10) Pub. No.: US 2004/0085018 A1
(43) Pub. Date: May 6, 2004

(54) Organic light-emitting display

(76) Inventor: Chih-Ming Kuo, Sanchung City (TW)

Correspondence Address: BIRCH STEWART KOLASCH & BIRCH, PO BOX 747, FALLS CHURCH, VA, 22040-0747, US

(21) Appl. No.: 10/449,766

(22) Filed: Jun. 2, 2003

(30) Foreign Application Priority Data
Jun. 3, 2002 (TW) 091111910

(51) Int. Cl. H01J 1/62

(52) U.S. Cl. 313/506

(57) ABSTRACT

An organic light-emitting display includes a transparent substrate, a transparent anode, an organic functional layer, a cathode and an insulator. In this case, the transparent anode is formed on the transparent substrate. The organic functional layer is formed on the transparent anode. The cathode is formed on the organic functional layer. The insulator is formed on the cathode and a part of the insulator permeates into the organic functional layer.

### BACKGROUND OF THE INVENTION

1. Field of the Invention

The invention relates to an organic light-emitting display, and in particular, to an organic light-emitting display, which further includes an insulator.

2. Description of the Related Art

Since organic light-emitting displays possess the advantages of self-emissive, full viewing angle, high power efficiency, easily manufactured, low cost, rapid response, and full color, the organic light-emitting displays may become the major choice for flat panel display technology in the future.

Referring to FIG. 1, an organic light-emitting display 3 is mainly consisted of a transparent substrate 31, a transparent anode 32, an organic functional layer 33, and a cathode 34. When applying a direct current to the display 3, holes are injected from the transparent anode 32 into the organic functional layer 33 while electrons are injected from the cathode 34. Based on the applied voltage, the holes and electrons are moved in the organic functional layer 33, and are recombined to generate excitons. The excitons can excite materials of the organic functional layer 33, so that the excited materials emit light to release energy.

As shown in FIG. 2a, however, during the manufacturing processes of the organic light-emitting display 3, no matter how critical the cleanliness of the clean room is controlled, there are several impurities 4, such as bubbles or particles, which may exist in the organic light-emitting display 3. Thus, the cathode 34 formed later may contact or substantial contact the transparent anode 32 to cause a substantial short circuit portion of the display 3. Alternatively, as shown in FIG. 2b, if the surface of the transparent anode 32 is rough (i.e. when a tip or tips are formed on the surface of the transparent anode 32), the short circuit portion or portions may occur. In such cases, since current may only pass through the short circuit portion or portions, not all of pixels can be driven. This causes the screen defects of the organic light-emitting display 3. Moreover, since the entire display, which has defects, has to be discarded directly, the product yield of the organic light-emitting display decreases.

### SUMMARY OF THE INVENTION

It is therefore an objective of the invention to provide an organic light-emitting display, which has an insulator to repair a pixel defect or defects.

To achieve the above-mentioned objective, the invention provides an organic light-emitting display, including a transparent substrate, a transparent anode, an organic functional layer, a cathode, and an insulator. In the invention, the transparent anode is formed on the transparent substrate. The organic functional layer is formed on the transparent anode. The cathode is formed on the organic functional layer. The insulator is formed on the cathode, and a part of the insulator permeates into the organic functional layer.

Since the invention provides an organic light-emitting display having an insulator, the display of the invention can prevent the short circuit portion or portions caused by that the anode and the cathode are too close or contact to each other. Thus, the screen defects of the organic light-emitting display caused by the error of driving the pixels can be avoided. Furthermore, the pixel having the short circuit portion or portions can be repaired so as to make the pixel with defects have the same light-emitting abilities, such as efficiency, brightness, color purity, and the like, as properly functioning adjacent pixels without defects. Accordingly, since the organic light-emitting display of the invention can be repaired without discarding the entire display, the product yield of the organic light-emitting displays of the invention increases.

### BRIEF DESCRIPTION OF THE DRAWINGS

The invention will become more fully understood from the detailed description given in the herein below illustration only, and thus are not limitative of the invention, and wherein:

FIG. 1 is a schematic illustration showing a conventional organic light-emitting display;

FIGS. 2a and 2b are schematic illustrations showing a substantial short circuit portion of the conventional organic light-emitting display; and

FIGS. 3a and 3b are schematic illustrations showing an organic light-emitting display according to an embodiment of the invention.

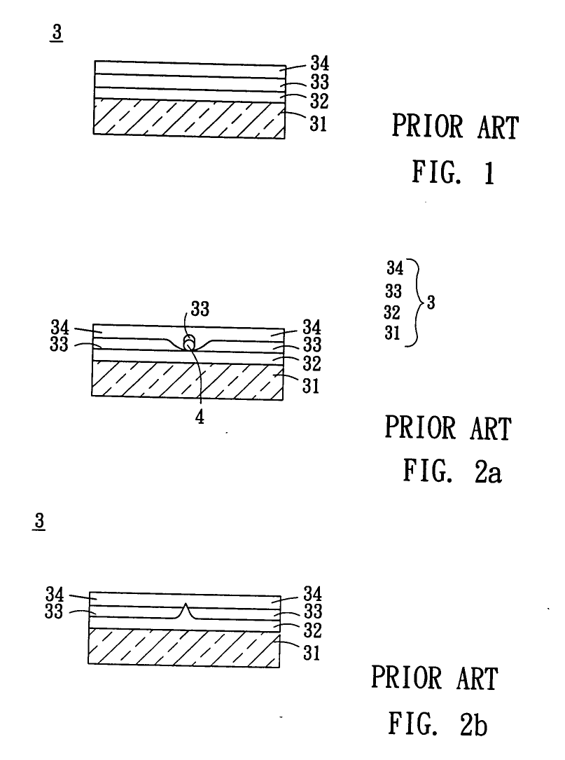

### DETAILED DESCRIPTION OF THE INVENTION

The organic light-emitting display according to an embodiment of the invention will be described with reference to the accompanying drawings.

The invention can repair the substantial short circuit portion, where the cathode contacts to or substantial contacts to the transparent anode as described in the related art.

It should be noted that an organic light-emitting display includes a pixel array including a plurality of pixels. To simplify the description, only one pixel is described in the following embodiment of the invention.

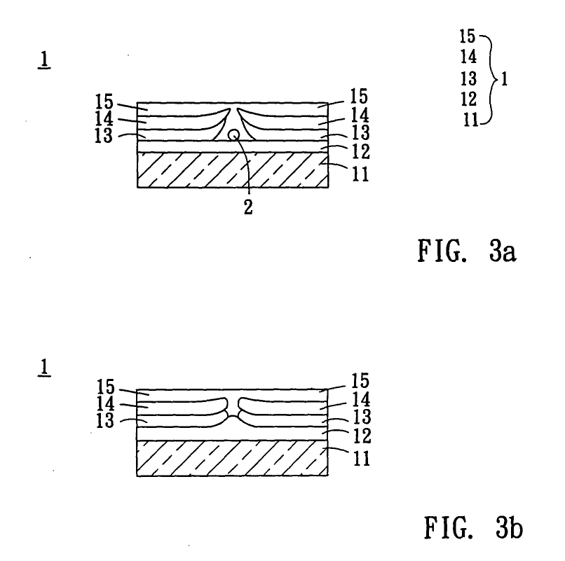

Referring to FIGS. 3a and 3b, an organic light-emitting display 1 of the invention includes a transparent substrate 11, a transparent anode 12, an organic functional layer 13, a cathode 14, and an insulator 15. In the embodiment, the transparent anode 12 is formed on the transparent substrate 11, the organic functional layer 13 is formed on the transparent anode 12, the cathode 14 is formed on the organic functional layer 13, and the insulator 15 is formed on the cathode 14. Wherein, a part of the insulator 15 penetrates into the organic functional layer 13.

The transparent substrate 11 according to the embodiment is a glass substrate, a plastic substrate, or a flexible substrate. In this embodiment, the plastic substrate or the flexible substrate may be a polycarbonate (PC) substrate or a polyester (PET) substrate, and the thickness of the transparent substrate 11 is about 0.2 mm to 5 mm.

In the current embodiment, the transparent anode 12 is formed on the transparent substrate 11 by utilizing sputtering or ion plating. The transparent anode 12 is made of an electro conductive metal oxide such as indium-tin oxide (ITO), or aluminum-zinc oxide (AZO). The thickness of the transparent anode 12 is more than 500 Å.

The organic functional layer 13 includes a hole injection layer, a hole transporting layer, an organic electroluminescent layer, an electron transporting layer, and an electron injection layer. In this case, the hole injection layer is mainly composed of copper phthalocyanine (CuPc), the hole transporting layer is mainly composed of 4,4′-bis[N-(1-naphthyl)-N-phenylamino]biphenyl (NPB), the electron injection layer is mainly composed of lithium fluoride (LiF), and the electron transporting layer is mainly composed of tris(8-quinolinato-N1,08)-aluminum (Alq). The organic functional layer 13 can be formed on the transparent anode 12 by utilizing evaporation, spin coating, ink jet printing, or printing. The thickness of the organic functional layer 13 is about 500 Å to 3000 Å. In addition, the organic functional layer 13 may emit blue light, green light, red light, white light, or other monochrome light.

The cathode 14 is formed by utilizing evaporation, E-gun coating, or sputtering. In the current embodiment, the cathode 13, which has a thickness of 500 Å to 5000 Å, is made of aluminum, aluminum/lithium, calcium, magnesium-silver alloys, or silver.

In the invention, the insulator 15 is formed on the cathode 14, and a part of the insulator 15 penetrates into the organic functional layer 13 as shown in FIGS. 3a and 3b. In this embodiment, the insulator 15 may be made of an organic material such as that used to form the organic functional layer 13. For example, the organic material may be the material of a hole injection layer, a hole transporting layer, an organic electroluminescent layer, an electron transporting layer or an electron injection layer of the organic functional layer 13. The insulator 15 may also be formed of an inorganic material having high resistance such as silicon nitride, or silicon oxide. Moreover, when the manufacturing processes are performed in connection with a passivation forming system, a polymer, such as fluorocarbon resin or parylene having a high resistance, may be used as the material of the insulator 15.

In the manufacturing processes of the organic light-emitting display, since the cleanliness of the clean room environment is insufficient, impurities, such as bubbles or particles, may exist in the organic light-emitting display. Thus, the cathode may contact or substantial contact the transparent anode so as to form the substantial short circuit portion or portions (as shown in FIG. 2a). In term of a single pixel, the current may only pass through the substantial short circuit portion or portions, so that the entire pixel cannot be driven.

In the current embodiment, the insulator 15 is formed in a buffer chamber or a single chamber. A positive voltage and a negative voltage are respectively applied to the transparent anode 12 and the cathode 14. In such a case, since the organic light-emitting display 1 has impurities, explosion may occur at the places where the impurities located. Thus, the organic functional layer 13 and the cathode 14 may curve outwardly, so that the substantial short circuit portion or portions of the organic light-emitting display 1 can be transformed to an open circuit portion or open circuit portions. After that, the insulator 15 as shown in FIG. 3a is coated on the open circuit portion or portions by vacuum evaporation. Alternatively, a negative voltage and a positive voltage may be applied to the transparent anode 12 and the cathode 14, respectively, so as to cause the explosion at the places where the impurities located.

In the manufacturing of the organic light-emitting display, the film-formed surface of the transparent substrate 11 often faces downwards. Thus, if the insulator 15 is not formed on the open circuit portion or portions immediately, as long as the film-formed surface of the transparent substrate 11 is turned upward by any chance in the subsequent manufacturing steps, the curved cathode 14 may contact the transparent anode 12 to form the short-circuited structure again.

In the embodiment, the cathode 14 can be oxidized in a moisture-free and oxygen-containing atmosphere, so as to form an oxide layer on the surface of the cathode 14. The oxide layer, which is the insulator 15, is capable of isolating the cathode 14 and the transparent anode 12, so as to protect the open circuit portion or portions.

In addition, if the surface of the transparent anode 12 is rough, the substantial short circuit portion or portions may exist as shown in FIG. 2b.

Similarly, when a positive voltage and a negative voltage are respectively applied to the transparent anode 12 and the cathode 14, the thinner portion of the organic functional layer 13 or the tips of the transparent anode 12 may has heat generated caused by the concentrated current during a constant voltage is charged between the substantial short circuit portion or portions. Accordingly, the tips of the transparent anode 12 is melted, and parts of the stacked organic functional layer 13, which are opposite to the tips and have worse emitting efficiency, may be evaporated. The evaporated parts of the organic functional layer 13 may cause the explosion to transform the substantial short circuit portion or portions of the organic light-emitting display 1 to the open circuit portion or portions. Referring to FIG. 3b, the insulator 15 is then coated on the open circuit portion or portions by vacuum evaporation. Of course, the transparent anode 12 and the cathode 14 can be applied with a negative voltage and a positive voltage, respectively, so as to melt the tips of the transparent anode 12.

In the embodiment, the open circuit portion or portions, on which the insulator 15 is formed in the pixel, may represent as a dark spot or dark spots. The pixel, however, still has the same light-emitting abilities (e.g., efficiency, brightness, color purity, and the like) as those of properly functioning adjacent pixels without defects. Thus, the whole screen of the organic light-emitting display will not be affected seriously.

The organic light-emitting display of the invention includes an insulator, which is formed on the cathode and penetrates into the organic functional layer in part. Compared to the prior art, the organic light-emitting display of the invention can repair the short circuit portion or portions caused by that the anode and the cathode are too close or contact to each other. Furthermore, the current will not only pass through the short circuit portion or portions, and the entire pixel can be driven. Thus, the defect of the organic light-emitting display can be avoided. Moreover, since the defect caused by the short circuit portion or portions in the organic light-emitting display of the invention can be repaired, the pixel may have the same light-emitting abilities, such as efficiency, brightness, color purity, and the like, as those of its adjacent pixels without defects. Therefore, the organic light-emitting display having several pixels with defects is unnecessary to be discarded, so that the product yield can be further enhanced.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. An organic light-emitting display, comprising:
a transparent substrate;
a transparent anode, which is formed on the transparent substrate;
an organic functional layer, which is formed on the transparent anode;
a cathode, which is formed on the organic functional layer; and
an insulator, which is formed on the cathode, wherein a part of the insulator penetrates into the organic functional layer.

2. The display of claim 1, wherein the transparent substrate is a glass substrate.

3. The display of claim 1, wherein the transparent substrate is a plastic substrate.

4. The display of claim 1, wherein the transparent substrate is a flexible substrate.

5. The display of claim 1, wherein the transparent anode is an electro conductive metal oxide anode.

6. The display of claim 5, wherein the transparent anode is an indium-tin oxide (ITO) anode.

7. The display of claim 5, wherein the transparent anode is an aluminum-zinc oxide (AZO) anode.

8. The display of claim 1, wherein the organic functional layer comprises a hole injection layer.

9. The display of claim 1, wherein the organic functional layer comprises a hole transporting layer.

10. The display of claim 1, wherein the organic functional layer comprises an organic electroluminescent layer.

11. The display of claim 1, wherein the organic functional layer comprises an electron transporting layer.

12. The display of claim 1, wherein the organic functional layer comprises an electron injection layer.

13. The display of claim 1, wherein the cathode is made of aluminum.

14. The display of claim 1, wherein the cathode is made of magnesium-silver alloy.

15. The display of claim 1, wherein the insulator is made of the same material of a hole injection layer of the organic functional layer.

16. The display of claim 1, wherein the insulator is made of the same material of a hole transporting layer of the organic functional layer.

17. The display of claim 1, wherein the insulator is made of the same material of an organic electroluminescent layer of the organic functional layer.

18. The display of claim 1, wherein the insulator is made of the same material of an electron transporting layer of the organic functional layer.

19. The display of claim 1, wherein the insulator is made of the same material of an electron injection layer of the organic functional layer.

20. The display of claim 1, wherein the insulator is made of an inorganic material with high resistance.

21. The display of claim 1, wherein the insulator is an oxide of the cathode.

22. The display of claim 1, wherein the insulator is made of an organic material with high resistance.

23. The display of claim 1, wherein the insulator is made of a polymer material with high resistance.
